(19) United States
(12) Patent Application Publication
(10) Pub. No.: US 2005/0057484 A1
(43) Pub. Date: Mar. 17, 2005

(54) Automatic image luminance control with backlight adjustment

(76) Inventors: Paul S. Diefenbaugh, Beaverton, OR (US); David A. Wyatt, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/663,316

(22) Filed: Sep. 15, 2003

(51) Int. Cl. G09G 3/36

(52) U.S. Cl. 345/102

(57) ABSTRACT

Methods and apparatuses for adjusting backlight intensity in a display device of a computer system, and compensating with image brightness adjustments via graphics controller color-lookup table to retain a net equivalent level of brightness as perceived by the user when viewing images produced by the graphics controller on the display device.

### TECHNICAL FIELD

The invention relates to image luminance and display panel backlight control. More particularly the invention relates to adjusting image luminance values while providing corresponding panel backlight intensity.

### BACKGROUND

Because batteries provide power to operate a laptop computer or other portable electronic device for a limited period of time, a need exists to efficiently use the power available to provide the longest possible operating period. This need has resulted in various power saving techniques such as, for example, shutting down or reducing power in components that are not being heavily used, or where policy is to prefer power savings over performance.

One component that can have power reduced during periods of inactivity or when power conservation is preferred is the LCD panel and backlight. In a typical laptop computer, for example, the display can consume 30% or more of the power consumed by the system. In order to reduce display power consumption, some laptop computer systems reduce the panel backlighting when in battery-powered mode. However, because LCDs are transmissive display devices (i.e., LCDs depend on the quantity and quality of the backlight source for producing the perceived color gamut), reduction of backlight brightness alone results in an image that the user often perceives as of lower quality than the same image with a brighter backlighting.

Display image quality is further effected by ambient light surrounding the display, which can reduce the environments in which a user may feel comfortable using a battery powered device that adjusts the backlight to save power, which is especially important considering the self-contained battery power-source is one of the key factors facilitating mobility that allows the use to move at will between different indoor and outdoor environments.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of an electronic system.

FIG. 2 illustrates a cross-section of one embodiment of a flat-panel display monitor.

FIG. 3 illustrates a group of pixels within a flat-panel monitor screen.

FIG. 4 illustrates one embodiment of a light emitting diode (LED) backlight for a notebook computer display system.

FIG. 5 illustrates one embodiment of a display control system that can provide backlight control and image brightness control for a display device.

FIG. 6 is a flow diagram of one embodiment of image brightness control based on ambient light level.

FIG. 7 is one embodiment of a backlight adjustment versus ambient light curve that can be used to modify backlight intensity based on ambient light conditions.

FIG. 8 is an example embodiment of a user interface that can be used for setting parameters to be used with dynamic backlight adjustment.

### DETAILED DESCRIPTION

Methods and apparatuses for dynamically controlling image brightness and/or backlight intensity based on ambient light levels are described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

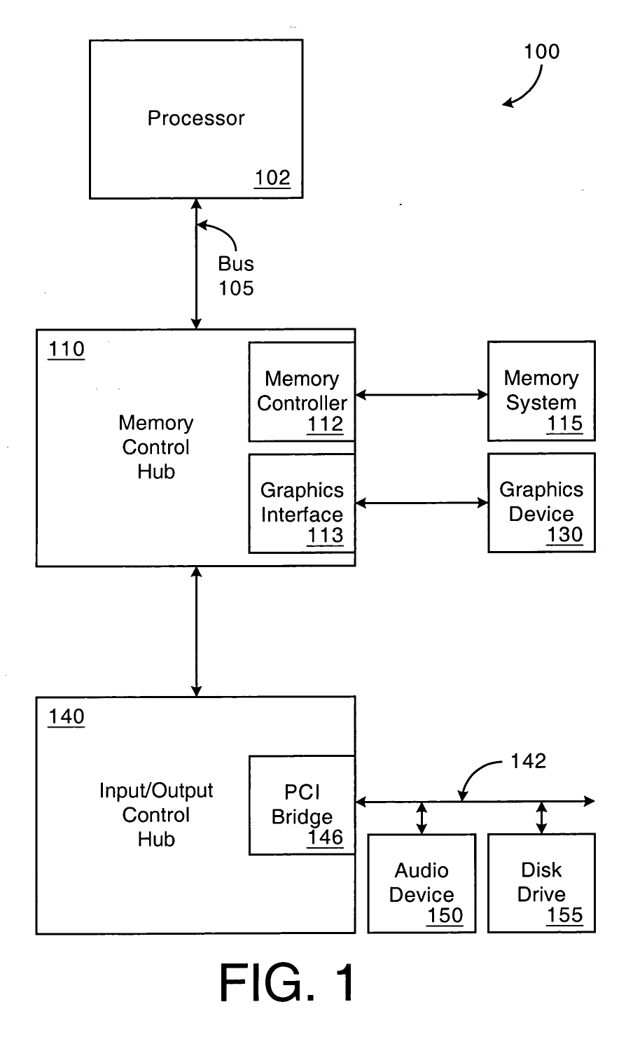

The image adaptation technique described herein can be applied to a broad class of electronic systems having associated display devices. While the examples herein a generally directed to laptop computers, the techniques described can be applied to personal digital assistants (PDAs), palm top computers, desktop computers using flat panel displays, kiosk displays, etc. FIG. 1 is a block diagram of one embodiment of an electronic system. Electronic system 100 includes processor 102 coupled to bus 105. In one embodiment, processor 102 is a processor in the Pentium® family of processors including the Pentium® II processor family, Pentium® III processors, Pentium® 4 processors, and Pentium-M processors available from Intel Corporation of Santa Clara, Calif. Alternatively, different and/or other processors may be used, such as Intel's StrongArm processor, XScale processor, ARM processors available from ARM Ltd. of Cambridge, the United Kingdom, or OMAP processor (an enhanced ARM-based processor) available from Texas Instruments, Inc., of Dallas, Tex.

Memory Control Hub (MCH) 110 is also coupled to the bus 105. MCH 110 may include memory controller 112 that is coupled to memory system 115. Memory system 115 stores data and sequences of instructions that are executed by processor 102 or any other device included in electronic system 100. In one embodiment, memory system 115 includes dynamic random access memory (DRAM); however, memory system 115 may be implemented using other memory types, for example, static random access memory (SRAM), or other configurations of integration, for example processor including memory controller. Additional and/or different devices not included in FIG. 1 may also be coupled to bus 105 and/or MCH 110.

MCH 110 may also include graphics interface 113 coupled to graphics device 130. In one embodiment, graphics interface 113 includes an accelerated graphics port (AGP) that operates according to an AGP Specification Revision 2.0 interface or PCI-Express Interface developed by Intel Corporation of Santa Clara, Calif. In another embodiment graphics device may be integrated with MCH forming a GMCH (Graphics and Memory Controller Hub). Other embodiments may be possible such as when MCH is integrated with the processor and Graphics Controller. In all cases Graphics Controller portion is referred to as Graphics Interface wherever contained therein.

In one embodiment, a flat panel display may be coupled to graphics interface 113 through, for example, a signal converter that translates a digital representation of an image stored in a storage device such as video memory or system memory into display signals that are interpreted and displayed by the flat-panel screen. Display signals produced by the display device may pass through various control devices before being interpreted by and subsequently displayed on the flat-panel display monitor. Other graphics interfaces and protocols can also be used.

MCH 110 is further coupled to input/output control hub (ICH) 140, which provides an interface to input/output (I/O) devices. ICH 140 may be coupled to, for example, a Peripheral Component Interconnect (PCI) bus adhering to a Specification Revision 2.1 bus developed by the PCI Special Interest Group of Portland, Oreg. Thus, in one embodiment, ICH 140 includes PCI bridge 146 that provides an interface to PCI bus 142. PCI bridge 146 provides a data path between processor 102 and peripheral devices. In another embodiment MCH and ICH are integrated together and also include PCI or other device/bridge function. In one embodiment, PCI bus 142 is coupled with audio device 150 and disk drive 155. However, other and/or different devices may be coupled to PCI bus 142. In addition, processor 102 and MCH 110 could be combined to form a single chip.

In addition, other and/or different peripheral devices may also be coupled to ICH 140 in various embodiments. For example, such peripheral devices may include integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Moreover, electronic system 100 can receive electrical power from one or more of the following sources for its operation: a battery, alternating current (AC) outlet (e.g., through a transformer and/or adaptor), automotive power supplies, airplane power supplies, and the like.

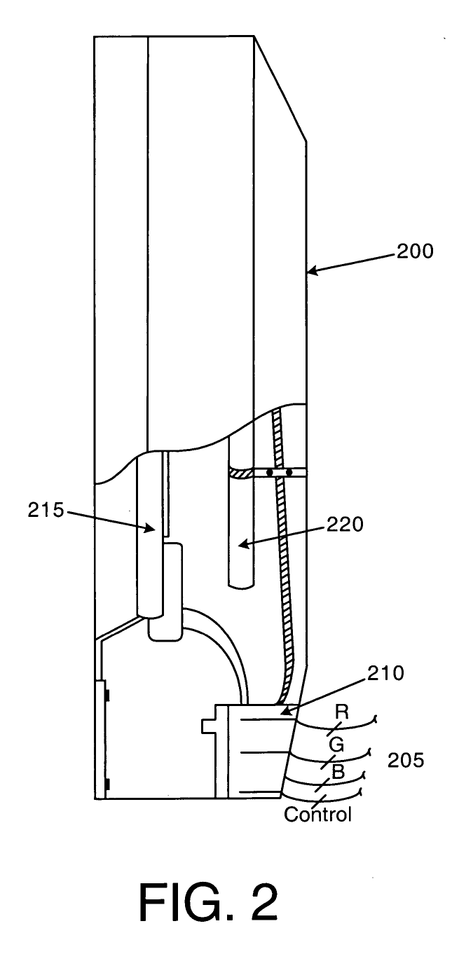

FIG. 2 illustrates a cross-section of one embodiment of a flat-panel display monitor. In one embodiment, display signals 205 generated by a display device, such as a graphics accelerator, are interpreted by flat-panel monitor control device 210 and subsequently displayed by enabling pixels within flat-panel monitor screen 215. The pixels are illuminated by backlight 220, the brightness of which effects the brightness of the pixels and therefore the brightness of the displayed image.

As described in greater detail herein, the brightness of backlight 220 can be adjusted to provide more efficient power usage, to provide appropriate brightness based on ambient conditions, and/or to compensate for image intensity changes. The color intensity values for the pixels can also be adjusted based on ambient conditions and/or backlight intensity.

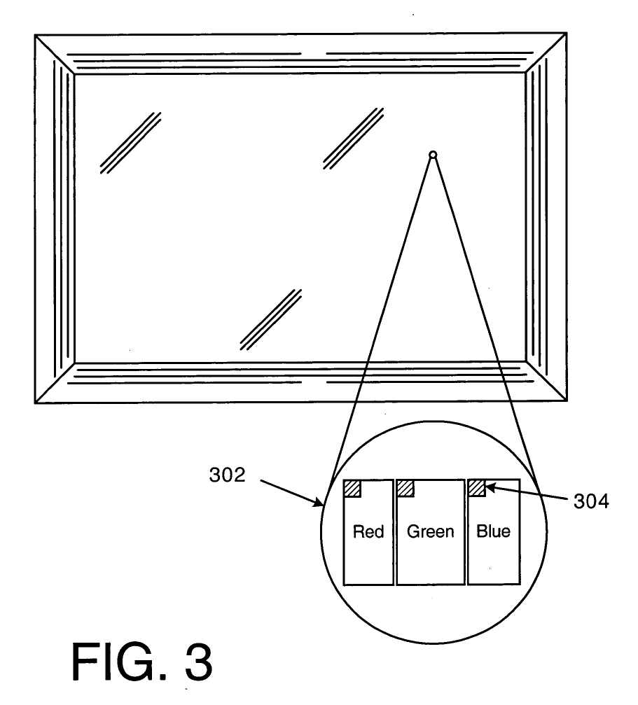

FIG. 3 illustrates a group of pixels within a flat-panel monitor screen. In one embodiment, the pixels are formed using thin film transistor (TFT) technology, and each pixel is composed of three sub-pixels 302 that, when enabled, cause a red, green, and blue (RGB) color to be displayed, respectively. Each sub-pixel is controlled by a TFT (e.g., 304). A TFT enables light from a display backlight to pass through a sub-pixel, thereby illuminating the sub-pixel to a particular color. Each sub-pixel color may vary according to a combination of bits representing the sub-pixel. The number of bits representing a sub-pixel determines the number of colors, or color depth, that may be displayed by a sub-pixel. Sub-pixel coloring is known in the art and any appropriate technique for providing sub-pixel coloring can be used.

A brighter or dimmer luminance of a color being displayed by a pixel can be achieved by scaling the value representing each sub-pixel color (red, green, and blue, respectively) within the pixel. The particular values used to represent different colors depends upon the color-coding scheme, or color space, used by the particular display device. By modifying the color luminance of the sub-pixels (by scaling the values representing sub-pixel colors) the perceived brightness of the display image may be modified on a pixel-by-pixel basis.

In one embodiment, color luminance is adjusted via modification of the color look-up table (gamma table) in a graphics controller, which adjust the sub-pixel colors prior to being sent to the display device. Furthermore, by modifying the color shade of each pixel, the amount of backlight necessary to create a display image of a particular display image quality can be modified accordingly. For example, increased brightness caused by manipulation of the color look-up table to provide opportunity to decrease backlight intensity and therefore a reduction in power consumption.

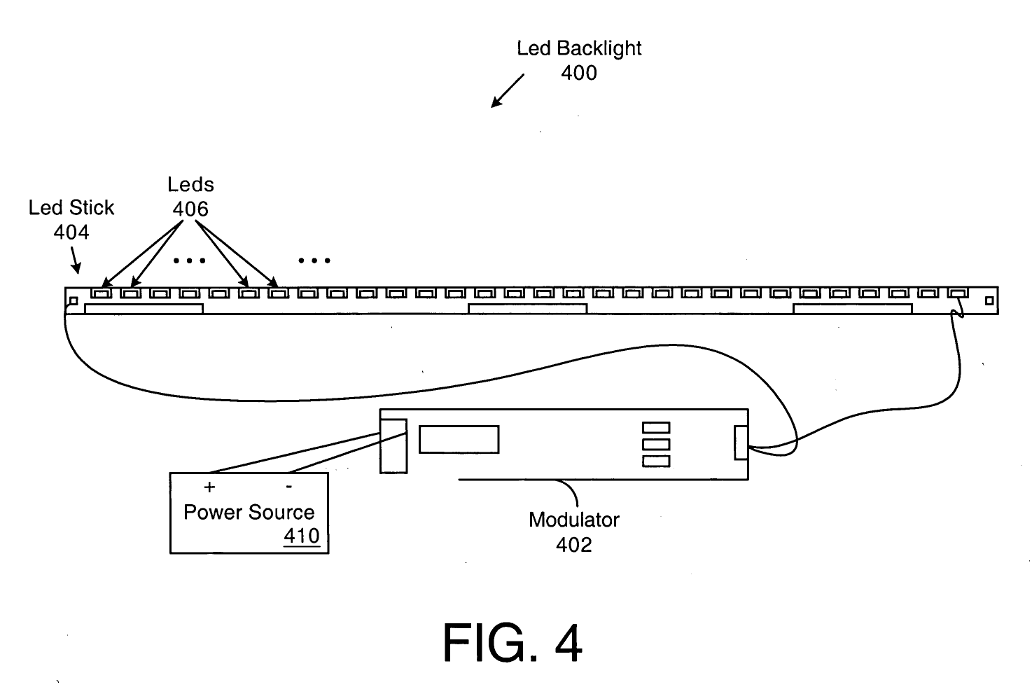

FIG. 4 illustrates one embodiment of a light emitting diode (LED) backlight for a notebook computer display system. In one embodiment, LED backlight 400 includes modulator 402, and LED stick 404, which includes LEDs 406. For example, LED stick 404 can include any number of LEDs. In one embodiment, LEDs 406 are white LEDs; however, LEDs 406 can be, for example, blue or ultraviolet LEDs. Modulator 402 receives power from power source 410, which can be a battery (e.g., a 12 Volt battery) or other power source. Modulator 402 controls the intensity of backlighting provided by LEDs 406.

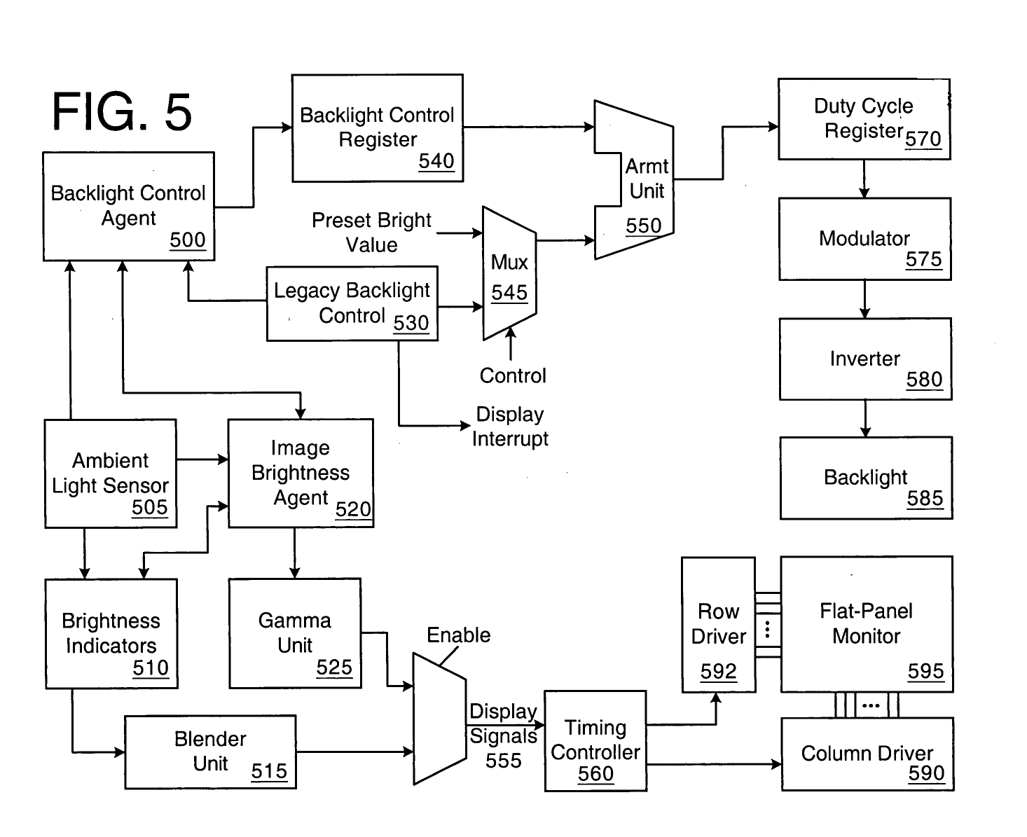

FIG. 5 illustrates one embodiment of a display control system that can provide backlight control and image brightness control for a display device. In one embodiment, the device for which flat-panel monitor 595 provides images, or an enclosure for flat-panel monitor 595 includes ambient light sensor 505. Flat-panel monitor 595 may be an LCD, plasma, or any type of flat-panel display. Alternatively, ambient light sensor 505 can be part of another component or be a separate component so long as ambient light sensor 505 provides information corresponding to the ambient light level in the environment in which flat-panel monitor 595 is to operate.

Output signals from ambient light sensor 505 are provided to backlight control agent 500 and image brightness agent 520. As described in greater detail below, the signals from the ambient light sensor can be used to dynamically adjust the image brightness and/or the backlight intensity in response to the ambient light conditions in which flat-panel monitor 595 is operating. Image brightness agent 520 and backlight control agent 500 can be implemented as hardware, software or a combination of hardware and software. In one embodiment, backlight control agent 500 and image brightness agent 520 are logically different components. Alternatively, backlight control agent 500 and image brightness agent 520 are included in a single component.

In one embodiment, image brightness agent 520 adjusts the perceived color brightness and contrast of an image to be displayed by modifying a look-up table in gamma unit 525 based on the ambient light level. In one embodiment, the backlight intensity can be modified to compensate for color intensity changes. In an alternate embodiment, backlight control agent 500 adjusts the intensity of the backlight based on the ambient light level and image brightness agent 520 compensates for the change in backlight intensity by adjusting image color brightness by modifying the look-up table in gamma unit 525.

In one embodiment, image brightness agent 520 receives one or more signals from ambient light sensor 505 indicating the ambient light level in the environment in which flat-panel monitor 595 operates. Image brightness agent 520 determines a level of image brightness and/or backlight intensity modification that can be made based on the ambient light level and communicates the color changes and/or desired backlight intensity changes to backlight control agent 500. In one embodiment, backlight control agent 500 writes value representing a scaling factor to backlight control register 540. As described in greater detail below, in one embodiment, the value stored in backlight control register 540 is combined with one or more other values to generate a duty cycle to control backlight intensity.

In general an image to be displayed on flat-panel monitor 595 is communicated via display signals 505, which enable timing controller 560 to activate appropriate column and row drivers 590 and 592, respectively, to display an image on flat-panel monitor 595. In one embodiment, blender unit 515 creates an image to be displayed on the display monitor by combining a display image with other display data, such as texture(s), lighting, and/or filtering data. These techniques are known in the art.

In one embodiment, the display image from blender unit 530 and the output of gamma unit 545 are combined generate display signals 505, which are transmitted to timing controller 510, as discussed above. Graphics gamma unit 545 determines the brightness (luminance) of pixels in an image to be displayed by scaling each sub-pixel color. In one embodiment, graphics gamma unit 545 can be programmed to scale the sub-pixel color on a per-pixel basis in order to achieve greater luminance in some areas of the display image, while reducing the luminance in other areas of the display image.

In one embodiment, display image brightness indicators 550 include data indicating image brightness determined by monitoring and accumulating pixel color within the display image. The display image brightness indicators can then indicate to image brightness agent 520 the brightness of certain features within the display image, such as display image character and background brightness.

As described above, backlight control agent 500 is coupled with ambient light sensor 505 and image brightness agent 520 to control the intensity of backlight 585. Backlight control agent 500 is also coupled with legacy backlight control register 530. In one embodiment, legacy backlight control register 530 is a PCI Config register in a graphics controller that is accessed by system BIOS or other hardware to provide a value used for direct legacy control of backlight intensity. In one embodiment, multiplexor 545 is coupled to legacy backlight control register 530 and to receive a preset brightness value (e.g., maximum brightness, baseline brightness).

Arithmetic unit 550 is coupled to receive a value stored in legacy backlight control register 540 and from multiplexor 545 (i.e., either the preset brightness value or the value stored in legacy backlight control register 530). Arithmetic unit 530 combines the values received from backlight control register 540 and multiplexor 545 to generate a backlight control value that is stored in duty cycle register 570. In one embodiment, a duty cycle of a pulse width modulated (PWM) signal is modified to cause a corresponding modification to the backlight intensity. In alternate embodiments, other techniques can be used to modify backlight intensity.

The value stored in duty cycle register 570 is used by modulator 575 to generate a signal to control the luminance (brightness) of backlight 585. In one embodiment, modulator 575 may include, or be coupled with, integrated inverter 580, for example, an industry Siemens flat panel display technology (I-SFT) inverter, which directly controls backlight 585.

In one embodiment, overall backlight intensity control can operate in one of three modes of operation. In a first mode of operation (pass-through mode) the duty cycle of the PWM signal generated by modulator 575 is determined by multiplying the value stored in backlight control register 540 with the value stored in legacy backlight control register 530. This allows values written to legacy backlight control register 530 to control the intensity of the light provided by backlight 585. In one embodiment, writing a value to legacy backlight control register 530 generates an interrupt that can be used to detect register accesses. Adjustments to the value stored in backlight control register 540 can be based on multiple factors as determined by backlight control agent 500. These factors can include, for example, ambient light level, user-provided parameters, power usage models and modes, etc.

In a second mode of operation (first capture mode), the duty cycle of the PWM signal is determined by the value stored in backlight control register 540. The value stored in legacy backlight register 530 as well as any updates to the value do not directly or indirectly affect the PWM signal. In one embodiment, an interrupt is generated with the value in legacy backlight register 530 is modified and the new value is stored in the register.

In a third mode of operation (second capture mode), the duty cycle of the PWM signal is set externally and writes to backlight control register 540 and legacy backlight control register 530 do not directly or indirectly affect the duty cycle of the PWM signal. In one embodiment, an interrupt is generated with the value in legacy backlight register 530 is modified and the new value is stored in the register.

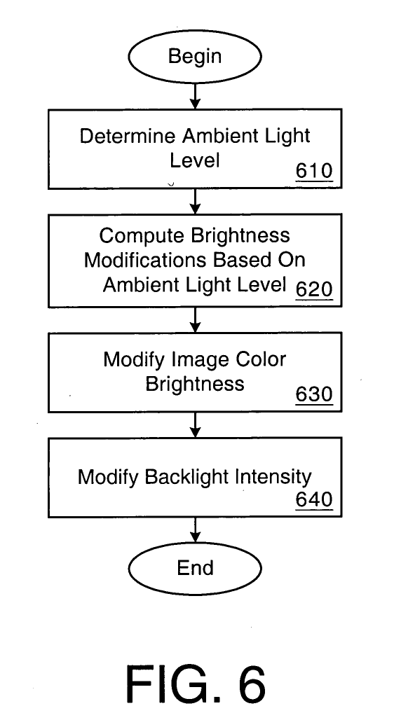

FIG. 6 is a flow diagram of one embodiment of image brightness control based on ambient light level. An ambient light level in an environment in which a display device is to be used is determined, 610. In one embodiment, the ambient light level is determined with an integrated ambient light sensor that provides electrical signals indicating the ambient light level. In alternate embodiments, the ambient light level can be determined using other techniques.

With the ambient light level, one or more control agents compute brightness modifications that can be made based on the ambient light level, 620. Brightness modifications can be, for example, dynamic modifications to the image color brightness table, or gamma table, used to determine the specific colors to be used in a displayed image and/or a backlight intensity level. For example, in a bright environment (e.g., outdoors on a sunny day or in a brightly lit room), maximum backlight intensity and/or increased color brightness may be used to provide an image that is easily viewed by the device user. As another example, in a dimly lit room, backlight intensity and/or decreased color brightness may be used to provide an image that is not perceived as too bright by the device user.

In one embodiment, the image color brightness is modified, 630, by modifying the color look up table for one or more colors. The backlight intensity is modified, 640 to compensate for the change in image brightness. In an alternate embodiment, the backlight intensity is modified and the image color brightness is modified to compensate for the change in backlight intensity.

In one embodiment, the goal of image brightness and backlight intensity control is to provide a constant user-perceived image brightness in a dynamically changing ambient environment. In a dimly-lit environment the backlight and/or image brightness can be decreased to offset the increased sensitivity of the human eye as the viewer's pupil dilates. The converse applies for brightly-lit environments. Usability studies suggest both a usability and a power savings benefit from these modifications.

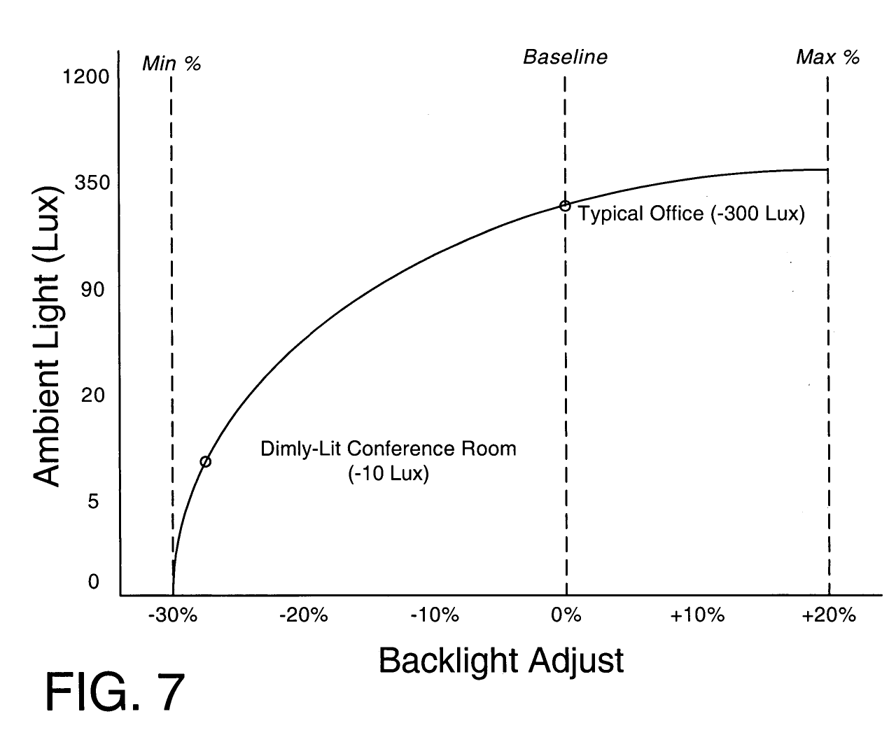

FIG. 7 is one embodiment of a backlight adjustment versus ambient light curve that can be used to modify backlight intensity based on ambient light conditions. In one embodiment, a backlight intensity baseline is established as a reference from which backlight intensity can be adjusted. The baseline value can be set by a device manufacturer, an operating system provider and/or can be modified by the device user. In one embodiment, the baseline backlight intensity is selected based on an anticipated common usage environment, for example, an office setting with an ambient light level of approximately 300 Lux.

In one embodiment, backlight intensity adjustment is made in terms of increased intensity and decreased intensity with respect to the baseline value between a minimum and a maximum. The minimum and maximum can be set by a device manufacturer, an operating system provider and/or can be modified by the device user. Any percentages with respect to the baseline value can be used within the operating range of the backlight.

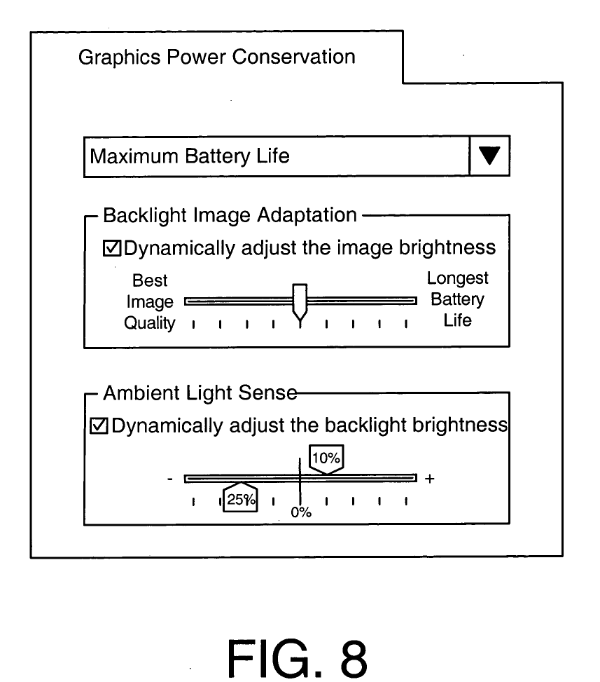

FIG. 8 is an example embodiment of a user interface that can be used for setting parameters to be used with dynamic backlight adjustment. The parameters provided through the user interface can be combined with the curve of FIG. 7 or can be used to modify the curve of FIG. 7. The backlight adjustment versus ambient light curve can be used by the image brightness agent and/or the backlight control agent to provide dynamic image brightness and backlight intensity modification as described above.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. A method comprising:
determining an ambient light level for an operating environment of a display device having an adjustable backlight to provide variable brightness; and
modifying a color brightness of one or more portions of an image to be displayed on the display device based on the ambient light level.

2. The method of claim 1 further comprising modifying the backlight intensity based on the modified color brightness.

3. The method of claim 2 wherein modification to the backlight intensity approximately offsets the modification to the color brightness.

4. The method of claim 1 wherein determining the ambient light level comprises receiving a signal from an ambient light sensor indicating the ambient light level.

5. The method of claim 1 wherein determining the ambient light level comprises receiving a user input.

6. The method of claim 1 wherein modifying the color brightness comprises modifying a color look-up table.

7. The method of claim 2 wherein modifying the backlight intensity comprises modifying a pulse width modulation signal that controls backlight illumination.

8. The method of claim 2 wherein modifying the backlight intensity comprises:
determining a hardware register value corresponding to a baseline backlight intensity value;
applying a software generated value to the register value to generate a modified backlight intensity value; and
using the modified backlight intensity value to the cause the backlight intensity to be modified.

9. The method of claim 8 wherein the baseline backlight intensity value is determined based on a user provided input.

10. The method of claim 8 wherein the baseline backlight intensity value is determined based on a power state of the display device.

11. The method of claim 8 wherein the hardware register value is stored in a register within a Peripheral Component Interconnect configuration space.

12. A method comprising:
determining an ambient light level for a display device having an adjustable backlight to provide variable backlight intensity;
modifying the backlight intensity based on the ambient light level; and
modifying a color brightness or one or more portions of an image to be displayed on the display device based on the modified intensity of the adjustable backlight.

13. The method of claim 12 wherein modification to the color brightness approximately offsets the modification to the backlight intensity.

14. The method of claim 12 wherein determining the ambient light level comprises receiving a signal from an ambient light sensor indicating an ambient light level.

15. The method of claim 12 wherein determining the ambient light level comprises receiving a user input.

16. The method of claim 12 wherein modifying the color brightness comprises modifying the color brightness comprises modifying a pixel color using a graphics controller look-up table prior to passing the pixel to the display device.

17. The method of claim 12 wherein modifying the backlight intensity comprises modifying a pulse width modulation signal that controls backlight illumination.

18. The method of claim 12 wherein modifying the backlight intensity comprises:
determining a hardware register value corresponding to a baseline backlight intensity value;
applying a software generated value to the register value to generate a modified backlight intensity value; and
using the modified backlight intensity value to the cause the backlight intensity to be modified.

19. The method of claim 18 wherein the baseline backlight intensity value is determined based on a user provided input.

20. The method of claim 18 wherein the baseline backlight intensity value is determined based on a power state of the display device.

21. The method of claim 18 wherein the hardware register value is stored in a register within a Peripheral Component Interconnect configuration space.

22. An apparatus comprising:
an ambient light sensor to generate signals indicating a sensed ambient light level;
a display device having an adjustable backlight source; and
a graphics control device coupled with the ambient light sensor on the display device, the graphics control device to modify image brightness and backlight intensity based on the sensed ambient light level.

23. The apparatus of claim 22 wherein the graphics control device modifies image brightness for one or more portions of an image to be displayed on the display device based on the sensed ambient light level and to modify the backlight intensity based on the modified image brightness.

24. The apparatus of claim 22 wherein the graphics control device modifies backlight intensity based on the sensed ambient light level and modifies the color brightness for one or more portions of an image to be displayed on the display device based on the modified backlight intensity.

25. The apparatus of claim 22 wherein the display device comprises a flat-panel liquid crystal display.

26. The apparatus of claim 22 wherein the display device comprises a plasma display device.

27. The apparatus of claim 22 wherein the graphics control device comprises:
a backlight control circuit coupled with the adjustable backlight source to control the intensity of backlight provided by the adjustable backlight source; and
a display control circuit coupled with the ambient light sensor and the backlight control circuit to apply an adjustment to a baseline backlight including at least the sensed ambient light level to generate a modified backlight intensity signal;
wherein the backlight control circuit causes the adjustable backlight source to provide a backlight intensity corresponding to the modified backlight intensity value.

28. The apparatus of claim 27 wherein the backlight control circuit provides a pulse width modulated signal to the adjustable backlight source to control the intensity of the backlight provided by the adjustable backlight source.

29. The apparatus of claim 27 wherein the baseline backlight intensity is retrieved from a register coupled with the backlight controller.

30. The apparatus of claim 27 wherein the adjustment to the baseline backlight intensity further comprises user-specified adjustment parameters.

31. The apparatus of claim 30 wherein the user-specified adjustment parameters comprise a range of desired backlight adjustments.

32. An article comprising a computer-readable medium having stored thereon instructions that, when executed, cause one or more processing devices to:
determine an ambient light level for a display device having an adjustable backlight to provide variable backlight intensity; and
modify a color brightness of one or more portions of an image to be displayed on the display device based on the ambient light level.

33. The article of claim 32 further comprising instructions that, when executed, cause the one or more processing devices to modify the backlight intensity based on the modified color brightness.

34. The article of claim 33 wherein modification to the backlight intensity approximately offsets the modification to the color brightness.

35. The article of claim 32 wherein the instructions that cause the one or more processing devices to determine the ambient light level comprise instructions that, when executed, cause the one or more processing devices to receive a signal from an ambient light sensor indicating the ambient light level.

36. The article of claim 32 wherein the instructions that cause the one or more processing devices to determine the ambient light level comprise instructions that, when executed, cause the one or more processing devices to receive a user input.

37. The article of claim 32 wherein the instructions that cause the one or more processing devices to modify the color brightness comprise instructions that, when executed, cause the one or more processing devices to adjust the pixel luminance, using color look-up table.

38. The article of claim 33 wherein the instructions that cause the one or more processing devices to modify the backlight intensity comprise instructions that, when executed, cause the one or more processing devices to modify a pulse width modulation signal that controls backlight illumination.

39. The article of claim 33 wherein the instructions that cause the one or more processing devices to modify the backlight intensity further comprise instructions that, when executed, cause the one or more processing devices to:
determine a hardware register value corresponding to a baseline backlight intensity value;
apply a software generated value to the register value to generate a modified backlight intensity value; and
use the modified backlight intensity value to the cause the backlight intensity to be modified.

40. The article of claim 39 wherein the baseline backlight intensity value is determined based on a user provided input.

41. The article of claim 39 wherein the baseline backlight intensity value is determined based on a power state of the display device.

42. An article comprising a computer-readable medium having stored thereon instructions that, when executed, cause one or more computing devices to:
determine an ambient light level for a display device having an adjustable backlight to provide variable backlight intensity;
modify the backlight intensity based on the ambient light level; and
modify a color brightness or one or more portions of an image to be displayed on the display device based on the modified intensity of the adjustable backlight.

43. The article of claim 42 wherein modification to the color brightness approximately offsets the modification to the backlight intensity.

44. The article of claim 42 wherein the instructions that cause the one or more processing devices to determine the ambient light level comprise instructions that, when executed, cause the one or more processing devices to receive a signal from an ambient light sensor indicating an ambient light level.

45. The article of claim 42 wherein the instructions that cause the one or more processing devices to determine the ambient light level comprise instructions that, when executed, cause the one or more processing devices to receive user input.

46. The article of claim 42 wherein the instructions that cause the one or more processing devices to modify the color brightness comprise instructions that, when executed, cause the one or more processing devices to adjust the pixel luminance, using color look-up table.

47. The article of claim 42 wherein the instructions that cause the one or more processing devices to modify the backlight intensity comprise instructions that, when executed, cause the one or more processing devices to modify a pulse width modulation signal that controls backlight illumination.

48. The article of claim 42 wherein the instructions that cause the one or more processing devices to modify the backlight intensity comprise instructions that cause the one or more processing devices to:
determine a hardware register value corresponding to a baseline backlight intensity value;
apply a software generated value to the register value to generate a modified backlight intensity value; and
use the modified backlight intensity value to the cause the backlight intensity to be modified.

49. The article of claim 48 wherein the baseline backlight intensity value is determined based on a user provided input.

50. The article of claim 48 wherein the baseline backlight intensity value is determined based on a power state of the display device.

51. A system comprising:
a bus;
an ambient light sensor coupled with the bus to generate signals indicating a sensed ambient light level;
an input/output controller coupled with the bus;
a display device having an adjustable backlight source; and
a graphics control device coupled with the ambient light sensor, the bus and the display device, the graphics control device to modify image brightness and backlight intensity based on the sensed ambient light level.

52. The system of claim 51 wherein the graphics control device modifies image brightness for one or more portions of an image to be displayed on the display device based on the sensed ambient light level and to modify the backlight intensity based on the modified image brightness.

53. The system of claim 51 wherein the graphics control device modifies backlight intensity based on the sensed ambient light level and modifies the color brightness for one or more portions of an image to be displayed on the display device based on the modified backlight intensity.

54. The system of claim 51 wherein the display device comprises a flat-panel liquid crystal display.

55. The system of claim 51 wherein the display device comprises a plasma display device.

56. The system of claim 51 wherein the graphics control device comprises:
a backlight control circuit coupled with the adjustable backlight source to control the intensity of backlight provided by the adjustable backlight source; and
a display control circuit coupled with the ambient light sensor and the backlight control circuit to apply an adjustment to a baseline backlight including at least the sensed ambient light level to generate a modified backlight intensity signal;
wherein the backlight control circuit causes the adjustable backlight source to provide a backlight intensity corresponding to the modified backlight intensity value.

57. The system of claim 56 wherein the backlight control circuit provides a pulse width modulated signal to the adjustable backlight source to control the intensity of the backlight provided by the adjustable backlight source.

58. The system of claim 56 wherein the baseline backlight intensity is retrieved from a register coupled with the backlight controller.

59. The system of claim 56 wherein the adjustment to the baseline backlight intensity further comprises user-specified adjustment parameters.

60. The system of claim 59 wherein the user-specified adjustment parameters comprise a range of desired backlight adjustments.
